(19) United States
(12) Patent Application Publication
(10) Pub. No.: US 2026/0001981 A1
(43) Pub. Date: Jan. 1, 2026

(54) ION CONDUCTIVE POLYMER AND SEPARATOR INCLUDING THE SAME

(71) Applicant: SK INNOVATION CO., LTD., Seoul (KR)

(72) Inventors: Cheol Woo KIM, Daejeon (KR); Dong Gun LEE, Daejeon (KR); So Young LEE, Daejeon (KR); Soo Min CHO, Daejeon (KR); Jong Chan KIM, Daejeon (KR); Jung A LEE, Daejeon (KR)

(21) Appl. No.: 18/985,029

(22) Filed: Dec. 18, 2024

(30) Foreign Application Priority Data
Jul. 1, 2024 (KR) 10-2024-0086408

(51) Int. Cl. C08G 10/04; C25B 13/08; H01M 8/0221

(52) U.S. Cl. CPC C08G 10/04; C25B 13/08; H01M 8/0221

(57) ABSTRACT

Embodiments of the present disclosure relate to an ion conductive polymer including a repeating unit of formula 1.

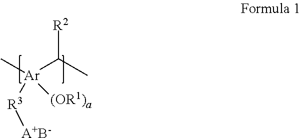

wherein in Formula 1, A⁺ is quaternary ammonium, B⁺ is an anion, a is an integer of 1 to 3, R¹ is an organic group having 1 to 10 carbon atoms, R² is H or an organic group having 1 to 10 carbon atoms, R³ is an organic group having 1 to 20 carbon atoms which includes at least one of an alkylene group or an arylene group, and Ar is a benzene ring.

### CROSS-REFERENCE TO RELATED APPLICATIONS

This patent document claims the priority and benefits of Korean Patent Application No. 10-2024-0086408 filed on Jul. 1, 2024, the disclosure of which is incorporated herein by reference in its entirety.

### BACKGROUND

### 1. Field of the Invention

Embodiments of the present disclosure generally relate to an ion conductive polymer and a separator including the ion conductive polymer.

### 2. Description of the Related Art

Generally, a separator is a barrier which exists between two different substances, and allows a specific substance to selectively pass therethrough. The separators may be divided into various types according to properties, materials, shapes, etc. thereof. In this case, an ion exchange membrane corresponds to a non-porous membrane, a symmetrical membrane, a single membrane, a homogeneous membrane, a hydrophilic membrane, a charged membrane, a liquid separator and the like.

The ion exchange membrane is a membrane having an ion exchange function for a specific ion, which is a type of high efficiency separator. When introducing an ion exchange membrane into an electrolyte solution and applying a current thereto, functional groups having positive or negative charges on pore walls of the membrane attract only specific ions having opposite charges into the pores of the membrane, thereby retaining electrical neutrality. The specific ions that have been bound to the functional groups of the membrane pass through the membrane by continuously repeating the binding and dissociation with the functional groups.

The ion exchange membranes may be classified into a cation exchange membrane (CEM), an anion exchange membrane (AEM), and a bipolar exchange membrane (BEM) according to characteristics thereof. The cation exchange membrane is a membrane which allows only cations to pass therethrough while anions serve as the fixed charges. The anion exchange membrane is a membrane which allows only anions to pass therethrough while cations serve as the fixed charges. The bipolar exchange membrane has a form in which cation and anion exchange membranes are coupled to both sides thereof, and allows both the cations and anions to selectively pass therethrough.

The ion exchange membrane may be used in various fields such as water treatment, chemistry, energy industries and the like. Since the ion exchange membrane should allow different specific charges to selectively pass therethrough, it is necessary to have low electrical resistance and high ionic conductivity. In addition, the ion exchange membrane should have excellent mechanical strength and be chemically stable in order to use continuously for a long period of time.

### SUMMARY

An embodiment of the present disclosure provides an ion conductive polymer having improved ionic conductivity.

Another embodiment of the present disclosure provides a separator including the ion conductive polymer having improved ionic conductivity.

An ion conductive polymer according to some embodiments of the present disclosure includes a repeating unit represented by Formula 1 below:

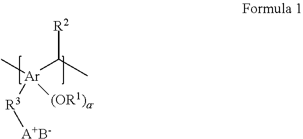

In Formula 1, A⁺ is quaternary ammonium, B⁻ is an anion, a is an integer of 1 to 3, R¹ is an organic group having 1 to 10 carbon atoms, R² is H or an organic group having 1 to 10 carbon atoms, R³ is an organic group having 1 to 20 carbon atoms, which includes at least one of an alkylene group or an arylene group, and Ar is a benzene ring.

In some embodiments, the B⁻ may be a monovalent or divalent anion.

In some embodiments, the B⁻ may be a halogen anion.

In some embodiments, the B⁻ may be a bromine anion (Br).

In some embodiments, the R¹ may be a methyl group (—CH₃).

In some embodiments, the R² may be an organic group having 1 to 8 carbon atoms.

In some embodiments, the R³ may be an organic group having 4 to 16 carbon atoms.

In some embodiments, the repeating unit represented by Formula 1 above may include at least one repeating unit represented by Formulas 1-1 to 1-5 below:

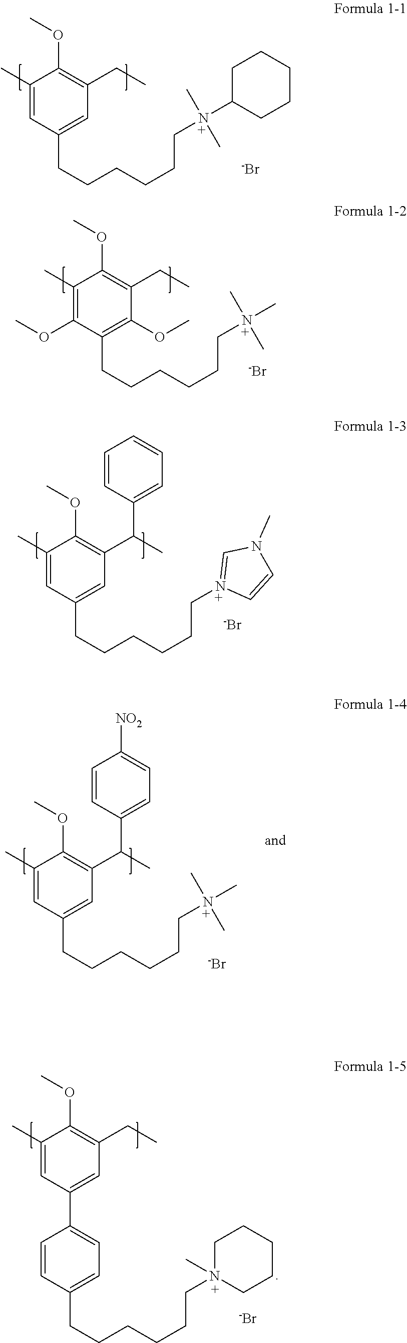

In some embodiments, an OH ionic conductivity of the ion conductive polymer may be 40 mS/cm to 80 mS/cm.

In a method for preparing an ion conductive polymer according to some embodiments of the present disclosure, a monomer having a benzene ring in which at least one alkoxy group is substituted is prepared. The monomer reacts with an aldehyde under mild acidic conditions to obtain a precursor polymer. A quaternary ammonium group is introduced into the precursor polymer to synthesize an ion conductive polymer including a repeating unit represented by Formula 1 below:

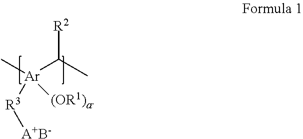

In Formula 1, A⁺ is quaternary ammonium, B⁻ is an anion, a is an integer of 1 to 3, R¹ is an organic group having 1 to 10 carbon atoms, R² is H or an organic group having 1 to 10 carbon atoms, R³ is an organic group having 1 to 20 carbon atoms, which includes at least one of an alkylene group or an arylene group, and Ar is a benzene ring.

A separator according to some embodiments includes the above-described ion conductive polymer.

A device according to some embodiments includes a cathode; an anode to face the cathode; and the above-described separator, which is disposed between the cathode and the anode.

In some embodiments, the device may include a water electrolysis device, a CO² electrolysis device, a fuel cell, an electrolytic cell, or a vanadium flow battery.

A separator according to some embodiments of the present disclosure includes a plurality of ion conductive polymer films laminated on each other, wherein each ion conductive polymer film includes a repeating unit represented by Formula 1,

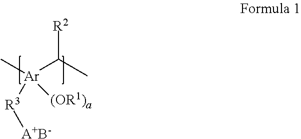

In Formula 1, A⁺ is quaternary ammonium, B⁻ is an anion, a is an integer of 1 to 3, R¹ is an organic group having 1 to 10 carbon atoms, R² is H or an organic group having 1 to 10 carbon atoms, R³ is an organic group having 1 to 20 carbon atoms which includes at least one of an alkylene group or an arylene group, and Ar is a benzene ring.

The ion conductive polymer according to some embodiments of the present disclosure may exhibit excellent ionic conductivity.

Since the separator according to some embodiments of the present disclosure includes the ion conductive polymer, it exhibits excellent ionic conductivity.

The ion conductive polymer and the separator of the present disclosure may be widely applied to green technology fields such as an electric vehicle, and a battery charging station, as well as solar power generation and wind power generation using batteries.

In addition, the ion conductive polymer and the separator of the present disclosure may be used in an eco-friendly electric vehicle, a hybrid vehicle, and the like, intended to prevent climate change by suppressing air pollution and greenhouse gas emissions.

### DETAILED DESCRIPTION

According to embodiments of the present disclosure, there is provided an ion conductive polymer including a repeating unit which includes quaternary ammonium and at least one ether group.

As the ion conductive polymer includes quaternary ammonium, stability and ionic conductivity thereof may be improved.

Considering the ion conductive polymer includes the ether group, synthesis of the polymer may be performed under mild acidic conditions.

Since the ion conductive polymer includes a main chain composed of carbon-carbon (C—C) bonds, physicochemical durability thereof may be improved.

Hereinafter, the present disclosure will be described in detail through embodiments. However, the embodiments are merely illustrative and the present disclosure is not limited to the specific embodiments described.

The ion conductive polymer according to some embodiments of the present disclosure includes a repeating unit represented by Formula 1 below.

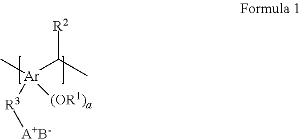

In some embodiments, A⁺ may be quaternary ammonium. In some embodiments, A⁺ may be a substituent including at least one methyl group. For example, A⁺ may be the quaternary ammonium.

In various embodiments of the present disclosure, the ammonium may also include ammonium in which two different substituents among substituents bonded to a nitrogen atom are linked to form a ring structure. For example, A⁺ may be trimethylammonium, triethylammonium, tripropylammonium, tributylammonium, imidazolium, piperidinium, quinuclidinium and the like.

In some embodiments, B⁻ may be an anion. In some embodiments, B⁻ may be a monovalent or divalent anion. For example, when B⁻ is a divalent anion, two A⁺ located on different chains may bind together to one B⁻ to form a cross-linked structure.

In some embodiments, B⁻ may be a halogen anion such as, for example, B⁻ may be a chloride anion (Cl⁻), a bromine anion (Br⁻), an iodine anion (I⁻), a hydroxide ion (OH⁻), a sulfate anion (SO₄²⁻), a carbonate anion (CO₃²⁻), a bicarbonate anion (HCO₃⁻), or a carboxylic acid anion (RCO₂⁻).

In some embodiments, the “a” in formula 1 may be an integer of 1 to 3. For example, “a” may be 1 or 3.

In some embodiments, R¹ may be an organic group having 1 to 10 carbon atoms.

In some embodiments, the organic group may be a substituent which includes only carbon and hydrogen, or includes one or more atoms other than carbon and hydrogen. For example, the atoms other than carbon and hydrogen may be nitrogen (N), oxygen (O), phosphorus (P), sulfur(S) and the like.

In some embodiments, R¹ may be an organic group having 1 to 6 carbon atoms. For example, R¹ may be a methyl group (—CH₃).

In some embodiments, the ion conductive polymer including the repeating unit represented by Formula 1 above may include an ether bond in a benzene ring. When the ether bond is included in the benzene ring, electrons of the benzene ring are placed in an electron-rich state. Accordingly, synthesis of the ion conductive polymer may be performed under relatively mild acidic conditions rather than under super-strong acidic conditions such as triflic acid.

According to some embodiments, the mild acid may have an acid dissociation constant (pKa) of −7 or more.

For example, the mild acid may be methanesulfonic acid, trifluoroacetic acid, nitric acid, sulfuric acid, hydrochloric acid and the like.

In some embodiments, R² may be H or an organic group having 1 to 10 carbon atoms.

In some embodiments, the organic group may be a hydrocarbon group, or a hydrocarbon group having one or more heteroatoms. The heteroatoms may be, for example, nitrogen (N), oxygen (O), phosphorus (P) or sulfur(S).

For example, the R² may be an organic group having 1 to 8 carbon atoms. Alternately, the R² may be an organic group having 1 to 6 carbon atoms.

In some embodiments, the R² may be further substituted with an electron withdrawing group (EWG). The electron withdrawing group may be, for example, a nitro group, a trifluoromethyl group, a cyano group, a fluoro group, an acyl group, etc. Accordingly, the synthesis of the ion conductive polymer may be more easily performed.

In some embodiments, the R³ may be an organic group having 1 to 20 carbon atoms, which includes at least one of an alkylene group or an arylene group. For example, the R³ may be an organic group having 4 to 16 carbon atoms. Alternatively, the R³ may be an organic group having 6 to 14 carbon atoms. Or otherwise, the R³ may be an organic group having 8 to 12 carbon atoms.

When the quaternary ammonium ion is directly linked to the benzene ring, the ammonium functional group may be decomposed by a bimolecular nucleophilic substitution (S_{N}2) reaction or a Hofmann elimination. When the S_{N}2 reaction occurs, the ammonium functional group may react with OH⁻ to be decomposed into an alcohol functional group and tertiary amine. When the Hofmann elimination occurs, a beta hydrogen atom of the ammonium functional group is attacked by OH⁻ to form a double bond, and decomposition of the ammonium functional group may occur. When the decomposition of the ammonium functional group occurs, the mechanical strength and ionic conductivity of the ion conductive polymer may be significantly decreased.

In the embodiments of the present disclosure, since the quaternary ammonium ion is linked to the benzene ring through R³, the electron withdrawing inductive effect and resonance effect by the benzene ring are reduced, such that the attack by OH⁻ may be decreased. Accordingly, the decomposition of the ammonium functional group may be prevented.

In some embodiments, the R³ may have aromatic and aliphatic chains mixed together therein. Accordingly, the mechanical strength of the ion conductive polymer may be further improved.

In some embodiments, the Ar may be a benzene ring.

In some embodiments, the repeating unit represented by Formula 1 above may include at least one of repeating units represented by Formulas 1-1 to 1-5 below.

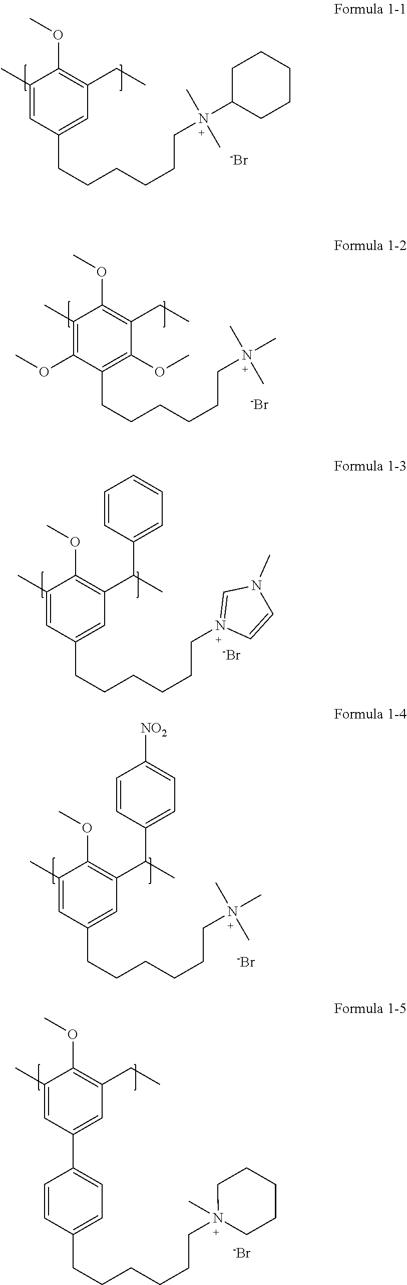

In some embodiments, an OH ionic conductivity of the ion conductive polymer may be 40 mS/cm to 80 mS/cm. For example, the OH ionic conductivity of the ion conductive polymer may be 43 mS/cm to 70 mS/cm, 45 mS/cm to 65 mS/cm, 46 mS/cm to 63 mS/cm, or 47 mS/cm to 60 mS/cm.

In one embodiment according to the present disclosure, there is provided a method for preparing an ion conductive polymer.

First, a monomer having a benzene ring in which at least one alkoxy group is substituted is prepared.

The alkoxy group may be —(OR¹), in Formula 1 above. Wherein, a may be an integer of 1 to 3.

The benzene ring may be bonded with R³ whose terminal is substituted with a halogen.

Next, the monomer reacts with an aldehyde under mild acidic conditions to obtain a precursor polymer.

When reacting the monomer with aldehyde under the mild acidic conditions (primary polymerization), a precursor polymer including the benzene ring in the main chain, may be obtained.

The primary polymerization may be carried out in the presence of a mild acid. As the mild acid, the above-described mild acids may be used. For example, an acid having a pKa of −7 or more may be used.

As described above, when an ether bond (alkoxy group) is included in the benzene ring, the electrons of the benzene ring are placed in the electron-rich state. Accordingly, the synthesis of the ion conductive polymer may be performed under relatively mild acidic conditions rather than the super-strong acidic conditions such as triflic acid (CF₃SO₃H).

The aldehyde may have R²—CHO, and after the primary polymerization, it will have a structure in which R² is linked to the main chain of the precursor polymer.

In some embodiments, R² may be further substituted with an electron withdrawing group, and in this case, the precursor polymer may be more easily produced by increasing the reactivity of the aldehyde.

Next, a quaternary ammonium group is introduced into the precursor polymer to synthesize the ion conductive polymer including the repeating unit represented by Formula 1 above.

The quaternary ammonium group may be introduced into a side chain of the benzene ring to exhibit ionic conductivity.

According to embodiments of the present disclosure, there is provided a separator including the ion conductive polymer.

In some embodiments, the separator may be prepared by laminating ion conductive polymer films including the repeating unit represented by Formula 1 above. That is, the separator may comprise a plurality of ion conductive polymer films each film being made from a polymer film including the repeating unit represented by Formula 1. The films may be laminated on each other using any suitable method.

According to embodiments of the present disclosure, there is provided a device including the separator. The device may include a cathode; an anode to face the cathode; and the separator disposed between the cathode and the anode. The device according to some embodiments may include a water electrolysis device, a CO₂ electrolysis device, a fuel cell, an electrolytic cell, or a vanadium flow battery and the like.

Hereinafter, embodiments are proposed as examples to facilitate understanding of the present disclosure, but these embodiments are only given for illustrating the scope of the present disclosure and are not intended to limit the appended claims. It will be apparent to those skilled in the art that various alterations and modifications are possible within the scope and spirit of the present disclosure, and such alterations and modifications are duly included in the appended claims.

### PREPARATIVE EXAMPLE 1: PREPARATION OF MONOMER

### (1) Preparation of Monomer 1 (A-1)

50 mL of dichloromethane, anisole (5 g, 46 mmol), and aluminum chloride (6.78 g, 51 mmol) were added to a 100 mL two-neck round bottom flask, and then the mixture was stirred inside an ice bath to prepare a mixed solution.

6-bromohexanoyl chloride (10.4 g, 49 mmol) was added gradually into the prepared mixed solution by using a syringe pump for a period of 2 hours, and then 85 mL of 1 M aqueous hydrochloric acid solution was added thereto. After completion of the reaction, the aqueous solution layer was removed through a separatory funnel and washed with 1 M aqueous sodium hydroxide solution. After washing, the aqueous solution layer was removed, and the organic solvent layer was dried over magnesium sulfate anhydrous, then the organic solvent was removed through a reduced pressure concentrator to obtain a solid. It is noted that the reaction is complete immediately after the addition of the 6-bromohexanoyl chloride. The completion of the reaction may be confirmed by TLC or H-NMR. For example, 1 M HCl may be added to quench the catalyst (AlCl₃), and it may be confirmed by visual observation as a clear solution with no residual solids.

Triethylsilane (16.1 g, 139 mmol), trifluoroacetic acid (5.3 g, 46 mmol), and the obtained solid were added into a 100 mL round bottom flask. A reflux condenser was installed in the round bottom flask, and then the mixture was stirred at 85° C. for 24 hours. After stirring, the mixture was cooled in an ice bath, and then 53 mL of 1 M aqueous sodium hydroxide solution was added thereto. The reaction is complete after 24 hours of stirring at 85° C. The completion of the reaction may be confirmed by TLC or H-NMR. For example, 1 M NaOH may be added to neutralize the trifluoroacetic acid used in the reaction. The completion of the neutralization may be confirmed by checking the basic condition using pH paper. After completion of the reaction, the aqueous solution layer was removed through a separatory funnel, then the organic solvent layer was dried over magnesium sulfate anhydrous and purified by column chromatography to prepare 11.1 g of a Monomer 1 (A-1) represented by Formula 2-1 below.

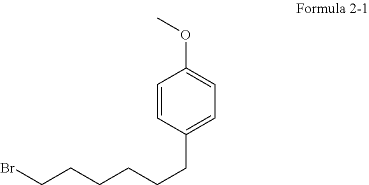

### (2) Preparation of Monomer 2 (A-2)

30 mL of dichloromethane, 1,3,5-trimethoxybenzene (3 g, 18 mmol), and aluminum chloride (2.85 g, 21 mmol) were added to a 100 mL two-neck round bottom flask, and then the mixture was stirred in an ice bath to prepare a mixed solution.

6-bromohexanoyl chloride (4.57 g, 21 mmol) was added into the prepared mixed solution through a syringe pump for 2 hours, and then 45 mL of 1 M aqueous hydrochloric acid solution was added thereto. After completion of the reaction, the aqueous solution layer was removed through a separatory funnel and washed with a 1 M aqueous sodium hydroxide solution. After washing, the aqueous solution layer was removed, and the organic solvent layer was dried over magnesium sulfate anhydrous, then the organic solvent was removed through a reduced pressure concentrator to obtain a solid.

Triethylsilane (6.1 g, 52 mmol), trifluoroacetic acid (1.98 g, 17 mmol), and the obtained solid were added into a 100 mL round bottom flask. A reflux condenser was installed in the round bottom flask, and then the mixture was stirred at 85° C. for 24 hours. After stirring, the mixture was cooled in an ice bath, and then 53 mL of 1 M aqueous sodium hydroxide solution was added thereto. After completion of the reaction, the aqueous solution layer was removed through a separatory funnel, then the organic solvent layer was dried over magnesium sulfate anhydrous and purified by column chromatography to prepare 3.65 g of Monomer 2 (A-2) represented by Formula 2-2 below.

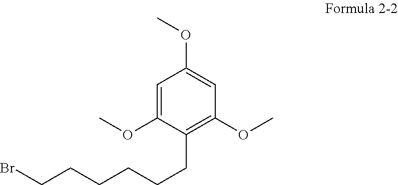 [SMILES: COc1cc(OC)c(CCCCCCBr)c(OC)c1]

### (3) Preparation of Monomer 3 (A-3)

75 mL of dichloromethane, 4-methoxybiphenyl (5 g, 27 mmol), and aluminum chloride (3.98 g, 30 mmol) were added to a 100 mL two-neck round bottom flask, and then the mixture was stirred in an ice bath to prepare a mixed solution.

6-bromohexanoyl chloride (6.08 g, 28 mmol) was added into the prepared mixed solution through a syringe pump for 2 hours, and then 50 mL of 1 M hydrochloric acid solution was added thereto. After completion of the reaction, the aqueous solution layer was removed through a separatory funnel and washed with a 1 M aqueous sodium hydroxide solution. After washing, the aqueous solution layer was removed, and the organic solvent layer was dried over magnesium sulfate anhydrous, then the organic solvent was removed through a reduced pressure concentrator to obtain a solid.

Triethylsilane (12.6 g, 109 mmol), trifluoroacetic acid (6.2 g, 54 mmol), and the obtained solid were added into a 100 mL round bottom flask. A reflux condenser was installed in the round bottom flask, and then the mixture was stirred at 85° C. for 24 hours. After stirring, the mixture was cooled in an ice bath, and then 60 mL of 1 M aqueous sodium hydroxide solution was added thereto. After completion of the reaction, the aqueous solution layer was removed through a separatory funnel, then the organic solvent layer was dried over magnesium sulfate anhydrous and purified by column chromatography to prepare 6.20 g of Monomer 3 (A-3) represented by Formula 2-3 below.

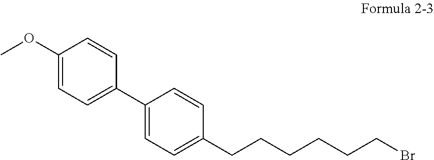 [SMILES: COc1ccc(-c2ccc(CCCCCCBr)cc2)cc1]

### PREPARATIVE EXAMPLE 2: PREPARATION OF POLYMER

### (1) Preparation of Polymer 1 (B-1)

14.8 mL of chloroform, 1.8 mL of methanesulfonic acid, paraformaldehyde (0.24 g, corresponding to 8 mmol of formaldehyde), and the prepared A-1 (2 g, 7 mmol) were added into a 25 mL round bottom flask. A reflux condenser was installed in the round bottom flask, and then the mixture was refluxed at 85° C. for 2 hours. After refluxing, the mixture was cooled to room temperature (25° C.) and 200 mL of methanol was added to precipitate a solid. The precipitated solid was filtered and washed twice with 50 mL of methanol, then dried in an oven to prepare 1.9 g of Polymer 1 (B-1) represented by Formula 3-1 below.

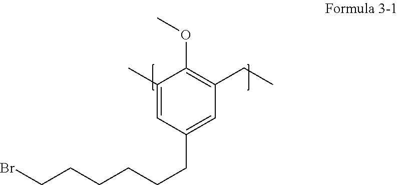

### (2) Preparation of Polymer 2 (B-2)

12.0 mL of chloroform, 1.5 mL of methanesulfonic acid, paraformaldehyde (0.20 g, corresponding to 7 mmol of formaldehyde), and the prepared A-2 (2 g, 6 mmol) were added into a 25 mL round bottom flask. A reflux condenser was installed in the round bottom flask, and then the mixture was refluxed at 85° C. for 2 hours. After refluxing, the mixture was cooled to room temperature (25° C.) and input into 200 mL of methanol to precipitate a solid. The precipitated solid was filtered and washed twice with 50 mL of methanol, then dried in an oven to prepare 1.6 g of Polymer 2 (B-2) represented by Formula 3-2 below.

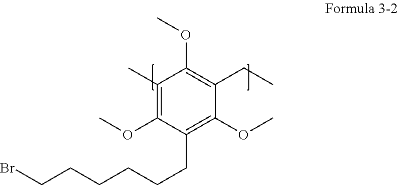

### (3) Preparation of Polymer 3 (B-3)

14.8 mL of chloroform, 1.8 mL of methanesulfonic acid, benzaldehyde (0.77 g, 7 mmol), and the prepared A-1 (2 g, 7 mmol) were added into a 25 mL round bottom flask. A reflux condenser was installed in the round bottom flask, and then the mixture was refluxed at 85° C. for 2 hours. After refluxing, the mixture was cooled to room temperature (25° C.) and input into 200 mL of methanol to precipitate a solid. The precipitated solid was filtered and washed twice with 50 mL of methanol, then dried in an oven to prepare 2.3 g of Polymer 3 (B-3) represented by Formula 3-3 below.

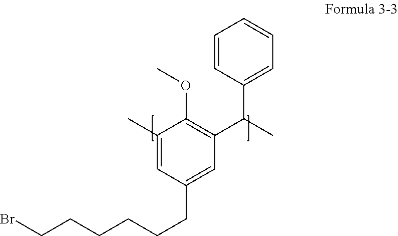

### (4) Preparation of Polymer 4 (B-4)

14.8 mL of chloroform, 1.8 mL of methanesulfonic acid, 4-nitrobenzaldehyde (1.09 g, 7 mmol), and the prepared A-1 (2 g, 7 mmol) were added into a 25 mL round bottom flask. A reflux condenser was installed in the round bottom flask, and then the mixture was refluxed at 85° C. for 2 hours. After refluxing, the mixture was cooled to room temperature (25° C.) and input into 200 mL of methanol to precipitate a solid. The precipitated solid was filtered and washed twice with 50 mL of methanol, then dried in an oven to prepare 3.0 g of Polymer 4 (B-4) represented by Formula 3-4 below.

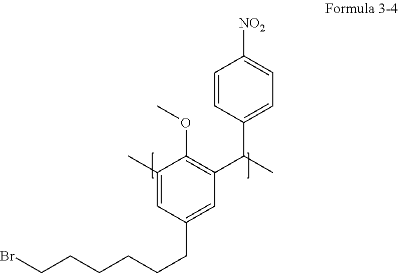

### (5) Preparation of Polymer 5 (B-5)

11.5 mL of chloroform, 1.44 mL of methanesulfonic acid, paraformaldehyde (0.61 g, corresponding to 20 mmol of formaldehyde), and the prepared A-3 (2 g, 6 mmol) were added into a 25 mL round bottom flask. A reflux condenser was installed in the round bottom flask, and then the mixture was refluxed at 85° C. for 2 hours. After refluxing, the mixture was cooled to room temperature (25° C.) and added into 200 mL of methanol to precipitate a solid. The precipitated solid was filtered and washed twice with 50 mL of methanol, then dried in an oven to prepare 1.7 g of Polymer 5 (B-5) represented by Formula 3-5 below.

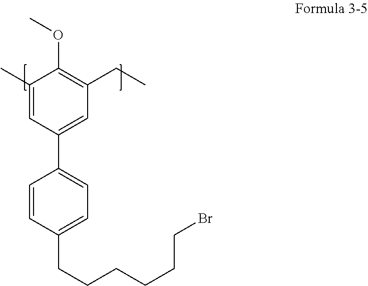

### Preparative Example 3: Preparation of Separator

### Example 1

1.45 mL of N-methyl pyrrolidone and 0.25 g of B-1 were input into a 20 mL glass vial, and the mixture was stirred at room temperature (25° C.). After B-1 was completely dissolved, 0.17 g of N,N-dimethylcyclohexylamine was added therein, and the mixture was stirred at 80° C. for 24 hours. After stirring, the mixture was cooled to room temperature (25° C.), and the cooled solution was poured into a petri dish, and then dried in an oven at 80° C. for 24 hours to prepare a separator (C-1) formed of the polymer including the repeating unit represented by Formula 1-1.

Results of ¹H-nuclear magnetic resonance (¹H-NMR) analysis performed on the prepared C-1 are as follows.

¹H-NMR (DMSO-d₆, ppm): 7.3(br,2H), 4.0(br, 2H) 3.8(br, 3H), 3.6-3.2(br, 9H), 2.6-2.5(br, 2H), 2.0-1.0(br, 18H)

### Example 2

2.12 mL of N-methyl pyrrolidone and 0.25 g of B-2 were added into a 20 mL glass vial, and the mixture was stirred at room temperature (25° C.). After B-2 was completely dissolved, 0.28 g of 28% by weight (“wt %”) of trimethylamine was input therein, and the mixture was stirred at 80° C. for 24 hours. After stirring, the mixture was cooled to room temperature (25° C.), and the cooled solution was poured into a petri dish, and then dried in an oven at 80° C. for 24 hours to prepare a separator (C-2) formed of the polymer including the repeating unit represented by Formula 1-2.

Results of ¹H-nuclear magnetic resonance spectroscopy analysis performed on the prepared C-2 are as follows.

¹H-NMR(DMSO-d₆, ppm): 3.9(br, 2H) 3.8(br, 9H), 3.3-3.2(br, 11H), 2.7-2.6(br, 2H), 2.0-1.0(br, 8H)

### Example 3

1.38 mL of N-methyl pyrrolidone and 0.25 g of B-3 were input into a 20 mL glass vial, and the mixture was stirred at room temperature (25° C.). After B-3 was completely dissolved, 0.10 g of 1-methylimidazole was input therein, and the mixture was stirred at 80° C. for 24 hours. After stirring, the mixture was cooled to room temperature (25° C.), and the cooled solution was poured into a petri dish, and then dried in an oven at 80° C. for 24 hours to prepare a separator (C-3) formed of the polymer including the repeating unit represented by Formula 1-3.

Results of ¹H-nuclear magnetic resonance spectroscopy analysis performed on the prepared C-3 are as follows.

¹H-NMR(DMSO-d₆, ppm): 8.92(br, 1H), 7.9-7.0(br, 9H), 5.48(br, 1H) 5.01(br, 2H), 3.9-3.7(br, 6H), 2.64(br, 2H), 2.1-1.2(br, 8H)

### Example 4

1.83 mL of N-methyl pyrrolidone and 0.25 g of B-4 were input into a 20 mL glass vial, and the mixture was stirred at room temperature (25° C.). After B-4 was completely dissolved, 0.21 g of 28 wt % of trimethylamine was input therein, and the mixture was stirred at 80° C. for 24 hours. After stirring, the mixture was cooled to room temperature (25° C.), and the cooled solution was poured into a petri dish, and then dried in an oven at 80° C. for 24 hours to prepare a separator (C-4) formed of the polymer including the repeating unit represented by Formula 1-4.

Results of ¹H-nuclear magnetic resonance spectroscopy analysis performed on the prepared C-4 are as follows.

¹H-NMR (DMSO-d₆, ppm): 8.16(br, 2H), 7.5-7.0(br, 4H), 5.50(br, 1H), 3.78(br, 3H), 3.5-3.0(br, 11H), 2.66(br, 2H), 1.8-1.2(br, 8H)

### Example 5

1.44 mL of N-methyl pyrrolidone, 1.44 g of dimethyl sulfoxide, and 0.25 g of B-5 were input into a 20 mL glass vial, and the mixture was stirred at room temperature (25° C.). After B-5 was completely dissolved, 0.1 g of N-methylpiperidine was input therein, and the mixture was stirred at 80° C. for 24 hours. After stirring, the mixture was cooled to room temperature (25° C.), and the cooled solution was poured into a petri dish, and then dried in an oven at 80° C. for 24 hours to prepare a separator (C-5) formed of the polymer including the repeating unit represented by Formula 1-5.

Results of 1H-nuclear magnetic resonance spectroscopy analysis performed on the prepared C-5 are as follows.

¹H-NMR (DMSO-d₆, ppm): 7.8-7.0(br, 6H), 4.0-3.8(br, 5H), 3.4-3.0(br, 9H), 2.63(br, 2H), 2.0-1.0(br, 14H)

### Comparative Example 1

Sustainion® X37-50 Grade RT product produced by Dioxide Materials was used.

### Comparative Example 2

Sustainion® X37-50 Grade T product produced by Dioxide Materials was used.

### Experimental Example: Evaluation of Ionic Conductivity of Separator

The membrane samples of the separators prepared in Examples 1 to 5 and Comparative Examples 1 to 2 were cut into 1 cm × 3 cm and fixed between Pt electrodes of a Conductivity Clamp (BT-110, Scribner).

An ionic conductivity (σ) of an anion exchange membrane was evaluated in the form of OH⁻ under conditions of room temperature (25° C.) and tertiary distilled water. A membrane resistance (R) was measured by means of a 4-point probe method using an impedance analyzer (VSP-3e, Biologics) in a frequency range of 0.1 kHz to 1 MHz. A thickness (T) of the membrane sample was measured using a micrometer.

The ionic conductivity (σ) was calculated using Equation 1 below, and results thereof are shown in Table 1 below.

$$σ = \frac{L}{R \times A} = \frac{L}{R \times W \times T} \qquad [ Equation 1 ]$$

In Equation 1, R is a membrane resistance (Ω), A is a cross-sectional area (cm²) of the membrane sample, L is a distance (cm) between electrodes, W is a width (cm) of the membrane sample, and T is a thickness (cm) of the membrane sample.

TABLE 1

| | OH ionic conductivity (mS/cm) |
|---|---|
| Example 1 | 50.6 |
| Example 2 | 47.1 |
| Example 3 | 43.3 |
| Example 4 | 46.7 |
| Example 5 | 45.5 |
| Comparative Example 1 | 38.0 |
| Comparative Example 2 | 32.7 |

Referring to Table 1, it can be confirmed that the OH ionic conductivities of Examples 1 to 5 are superior to the OH ionic conductivities of Comparative Examples 1 to 2.

Although the embodiments have been described in terms of specific examples, it is noted that the embodiments are not limited to the described examples only and many other variations and implementations of the disclosed invention may be envisioned by the skilled persons without departing from the scope of the present disclosure as defined in the appended claims. Furthermore, the embodiments may be combined to form additional embodiments.

What is claimed is:

1. An ion conductive polymer comprising a repeating unit represented by Formula 1 below: 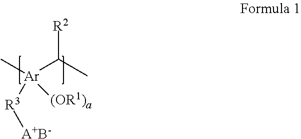
wherein in Formula 1, A⁺ is quaternary ammonium, B⁻ is an anion, a is an integer of 1 to 3, R¹ is an organic group having 1 to 10 carbon atoms, R² is H or an organic group having 1 to 10 carbon atoms, R³ is an organic group having 1 to 20 carbon atoms which includes at least one of an alkylene group or an arylene group, and Ar is a benzene ring.

2. The ion conductive polymer according to claim 1, wherein the B⁻ is a monovalent or divalent anion.

3. The ion conductive polymer according to claim 1, wherein the B⁻ is a halogen anion.

4. The ion conductive polymer according to claim 3, wherein the B⁻ is a bromine anion (Br).

5. The ion conductive polymer according to claim 1, wherein the R¹ is a methyl group (—CH₃).

6. The ion conductive polymer according to claim 1, wherein the R² is an organic group having 1 to 8 carbon atoms.

7. The ion conductive polymer according to claim 1, wherein the R³ is an organic group having 4 to 16 carbon atoms.

8. The ion conductive polymer according to claim 1, wherein the repeating unit represented by Formula 1 above comprises at least one of repeating units represented by Formulas 1-1 to 1-5 below:

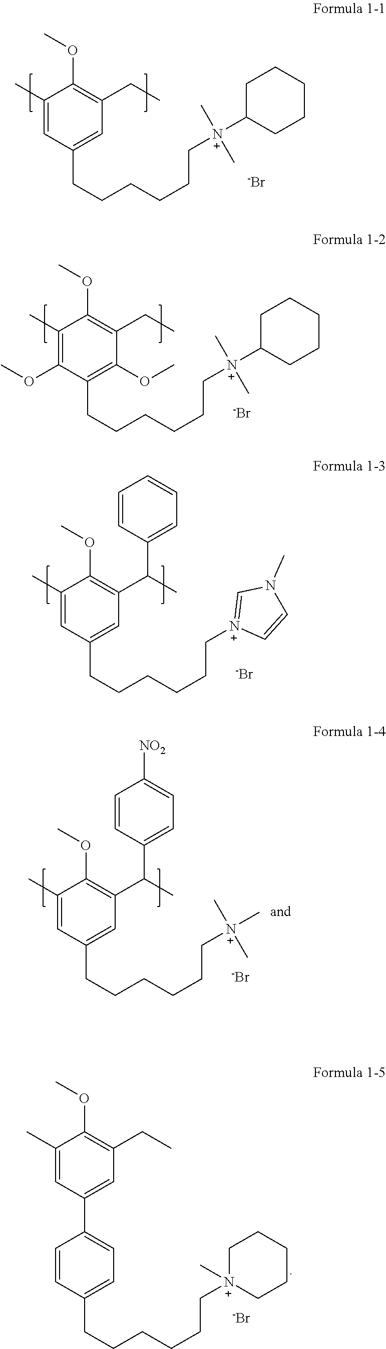

9. The ion conductive polymer according to claim 1, wherein an OH ionic conductivity of the ion conductive polymer is 40 mS/cm to 80 mS/cm.

10. A method for preparing an ion conductive polymer, the method comprising:
preparing a monomer having a benzene ring in which at least one alkoxy group is substituted;
reacting the monomer with an aldehyde under mild acidic conditions to obtain a precursor polymer; and
introducing a quaternary ammonium group into the precursor polymer to synthesize an ion conductive polymer including a repeating unit represented by Formula 1 below: 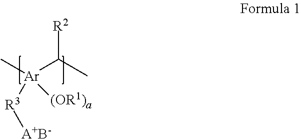
wherein in Formula 1, A⁺ is quaternary ammonium, B⁻ is an anion, a is an integer of 1 to 3, R¹ is an organic group having 1 to 10 carbon atoms, R² is H or an organic group having 1 to 10 carbon atoms, R³ is an organic group having 1 to 20 carbon atoms, which includes at least one of an alkylene group or an arylene group, and Ar is a benzene ring.

11. A separator comprising the ion conductive polymer according to claim 1.

12. A device comprising:
a cathode;
an anode to face the cathode; and
the separator according to claim 11, which is disposed between the cathode and the anode.

13. The device according to claim 12, wherein the device comprises a water electrolysis device, a CO₂ electrolysis device, a fuel cell, an electrolytic cell, or a vanadium flow battery.

14. A separator comprising a plurality of ion conductive polymer films laminated on each other, wherein each ion conductive polymer film includes a repeating unit represented by Formula 1, 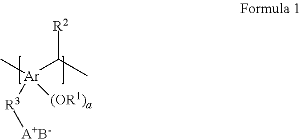
wherein in Formula 1, A⁺ is quaternary ammonium, B⁻ is an anion, a is an integer of 1 to 3, R¹ is an organic group having 1 to 10 carbon atoms, R² is H or an organic group having 1 to 10 carbon atoms, R³ is an organic group having 1 to 20 carbon atoms which includes at least one of an alkylene group or an arylene group, and Ar is a benzene ring.
